(19) United States
(12) Patent Application Publication
(10) Pub. No.: US 2011/0163039 A1
(43) Pub. Date: Jul. 7, 2011

(54) DEVICE AND METHOD FOR SEPARATING FERROMAGNETIC PARTICLES FROM A SUSPENSION

(76) Inventors: Vladimir Danov, Erlangen (DE); Andreas Schröter, Bickenriede (DE)

(21) Appl. No.: 13/063,797

(22) PCT Filed: Sep. 8, 2009
(86) PCT No.: PCT/EP2009/061612

§ 371 Date: Mar. 14, 2011

(30) Foreign Application Priority Data
Sep. 18, 2008 (DE) 10 2008 047 842.3

(51) Int. Cl. B03C 1/02

(52) U.S. Cl. 210/695; 210/222; 210/194

(57) ABSTRACT

A device for separating ferromagnetic particles from a suspension has a tubular reactor having at least one magnet, a suspension being able to flow through the reactor. The reactor (2) has at least one extraction line (3) branching off from the reactor (2), to which extraction line a negative pressure can be applied and which extraction line is surrounded by a permanent magnet (4) in the region of the branching.

### CROSS-REFERENCE TO RELATED APPLICATIONS

This application is a U.S. National Stage Application of International Application No. PCT/EP2009/061612 filed Sep. 8, 2009, which designates the United States of America, and claims priority to DE Application No. 10 2008 047 842.3 filed Sep. 18, 2008. The contents of which are hereby incorporated by reference in their entirety.

### TECHNICAL FIELD

The invention relates to a device for separating ferromagnetic particles from a suspension, comprising a tubular reactor through which the suspension can flow and which has at least one magnet.

### BACKGROUND

In order to extract ferromagnetic components which are contained in ores, the ore is ground into a powder and the powder obtained is mixed with water. A magnetic field generated by one or more magnets is applied to the suspension, as a result of which the ferromagnetic particles are attracted so that they can be separated from the suspension.

DE 27 11 16 A discloses a device for separating ferromagnetic particles from a suspension, in which a drum consisting of iron rods is used. The iron rods are alternately magnetized during the rotation of the drum, so that the ferromagnetic particles adhere to the iron rods while other components of the suspension fall down between the iron rods.

DE 26 51 137 A1 discloses a device for separating magnetic particles from an ore material, in which the suspension is fed through a tube which is surrounded by a magnetic coil. The ferromagnetic particles accumulate at the edge of the tube, while other particles are separated through a central tube which is located inside the tube.

A magnetic separator is described in U.S. Pat. No. 4,921,597 B. The magnetic separator comprises a drum, on which a multiplicity of magnets are arranged. The drum is rotated oppositely to the flow direction of the suspension, so that ferromagnetic particles adhere to the drum and are separated from the suspension.

A method for the continuous magnetic separation of suspensions is known from WO 02/07889 A2. This uses a rotatable drum in which a permanent magnet is fastened, in order to separate ferromagnetic particles from the suspension.

In known devices, a tubular reactor, through which the suspension flows, is used to separate the ferromagnetic particles from the suspension. One or more magnets, which attract the ferromagnetic particles contained in it, are arranged on the outer wall of the reactor. Under the effect of the magnetic field generated by the magnets, the ferromagnetic particles migrate onto the reactor wall and are held by the magnet arranged on the outside of the reactor. Although this allows effective separation, the separation method can however only be carried out discontinuously since after a particular quantity of the ferromagnetic particles have accumulated, the reactor has to be opened and the ferromagnetic particles removed. Only then is it possible for a new suspension to be supplied, or for the suspension already used once to be subjected to the separation method again.

### SUMMARY

According to various embodiments, a device for separating ferromagnetic particles from a suspension can be provided, with which the separation method can be carried out continuously and efficiently.

According to an embodiment, a device for separating ferromagnetic particles from a suspension, may comprise a tubular reactor through which the suspension can flow and which has at least one magnet, wherein the reactor has at least one suction line branching off from the reactor, to which a negative pressure can be applied and which is surrounded by a permanent magnet in the region of the branching.

According to a further embodiment, the permanent magnet can be surrounded by a coil winding which allows magnetic field control. According to a further embodiment, the device may comprise a plurality of suction lines arranged successively in the flow direction, each of which is surrounded by a permanent magnet in the region of the branching. According to a further embodiment, the device may comprises a plurality of suction lines arranged distributed in the circumferential direction of the reactor, each of which is surrounded by a permanent magnet in the region of the branching, neighboring permanent magnets being polarized alternately. According to a further embodiment, the suction line, and preferably each suction line, may comprise a controllable shut-off valve. According to a further embodiment, a plurality of suction lines can be connected together. According to a further embodiment, the suction line, in particular a plurality of or all of the suction lines, can be connected to a return line opening into the reactor. According to a further embodiment, the or a permanent magnet can be formed as a ring magnet.

According to another embodiment, in a method for separating ferromagnetic particles from a suspension, with a tubular reactor through which the suspension can flow and which has at least one magnet, the reactor has at least one suction line branching off from the reactor, to which a negative pressure can be applied, which is surrounded by a permanent magnet and via which the ferromagnetic particles are separated.

According to a further embodiment of the method, the permanent magnet can be surrounded by a coil winding which is driven by means of a magnetic field control device. According to a further embodiment of the method, in the case of a plurality of permanent magnets, each permanent magnet can be driven individually by means of the magnetic field control device. According to a further embodiment of the method, the suspension can be fed past a plurality of suction lines arranged successively in the flow direction and/or a plurality of suction lines arranged distributed in the circumferential direction of the reactor, each suction line being surrounded by a permanent magnet. According to a further embodiment of the method, the suspension can be fed back into the reactor via a return line connected to the or a suction line.

### BRIEF DESCRIPTION OF THE DRAWINGS

Other advantages and details of the invention will be explained with the aid of exemplary embodiments with reference to figures. The figures are schematic representations, in which:

FIG. 1 shows a device according to various embodiments for separating ferromagnetic particles from a suspension in a sectional view;

FIG. 2 shows the device of FIG. 1 with accumulated ferromagnetic particles;

FIG. 3 shows the device of FIG. 1 during suction of the accumulated ferromagnetic particles; and

FIG. 4 shows a device according to various embodiments in a plan view;

FIG. 5 shows another exemplary embodiment of the device.

### DETAILED DESCRIPTION

According to various embodiments, in a device of the type mentioned in the introduction, the reactor has at least one suction line branching off from the reactor, to which a negative pressure can be applied and which is surrounded by a permanent magnet in the region of the branching. In the device according to various embodiments, separated ferromagnetic particles can be extracted through the suction line and thereby separated from the suspension. The device according to various embodiments therefore has the advantage that the reactor does not need to be stopped in order to remove the ferromagnetic particles from the suspension. Accordingly, the separation of the ferromagnetic particles can be carried out continuously with the device according to various embodiments.

According to an embodiment, the permanent magnet may be surrounded by a coil winding which allows magnetic field control. The magnetic field of the permanent magnet can be increased or decreased by the magnetic field control. In this way, it is possible to adapt the region of influence inside which ferromagnetic particles are attracted, and subsequently separated from the suspension via the suction line.

The device according to various embodiments may particularly advantageously comprise a plurality of suction lines arranged successively in the flow direction, each of which is surrounded by a permanent magnet in the region of the branching. The plurality of suction lines may be arranged in cascade fashion in the flow path of the suspension, so that further ferromagnetic particles are removed from the suspension as the suspension flows through the reactor.

The device according to various embodiments may also comprise a plurality of suction lines arranged distributed in the circumferential direction of the reactor, each of which is surrounded by a permanent magnet in the region of the branching. With such arrangement, virtually the entire flow cross section can be exposed to a magnetic field so that a very large fraction of the ferromagnetic particles contained in the suspension can be removed from the suspension by means of the suction lines. It is particularly preferable for the suction line of the device according to various embodiments, and preferably each suction line, to comprise a controllable shut-off valve. Each shut-off valve can be opened and closed by a control device. When a shut-off valve is opened, the ferromagnetic particles which have accumulated under the effect of the magnetic field enter the suction line owing to the negative pressure and can be collected at another position. The negative pressure may, for example, be generated by a pump or the like.

A plurality of suction lines may also be connected together. Suction lines connected together can be used simultaneously to suction accumulated magnetic particles by opening the associated shut-off valves simultaneously. If a plurality of suction lines are connected together, a single negative pressure generation device, for instance a pump, is sufficient in order to suction the ferromagnetic particles from all the suction lines.

An even higher efficiency can be achieved if, in the device according to various embodiments, the suction line, in particular a plurality of or all of the suction lines, is or are connected to a return line opening into the reactor. Owing to the return line, a suspension can be supplied to the reactor repeatedly until the proportion of ferromagnetic particles contained has fallen below an established limit.

In the device according to various embodiments, the or a permanent magnet may be formed as a ring magnet so that it surrounds the suction line.

According to other embodiments, a method for separating ferromagnetic particles from a suspension, comprises arranging a tubular reactor through which the suspension can flow and which has at least one magnet.

In the method according to various embodiments, the reactor has at least one suction line branching off from the reactor, to which a negative pressure can be applied, which is surrounded by a permanent magnet and via which the ferromagnetic particles are separated.

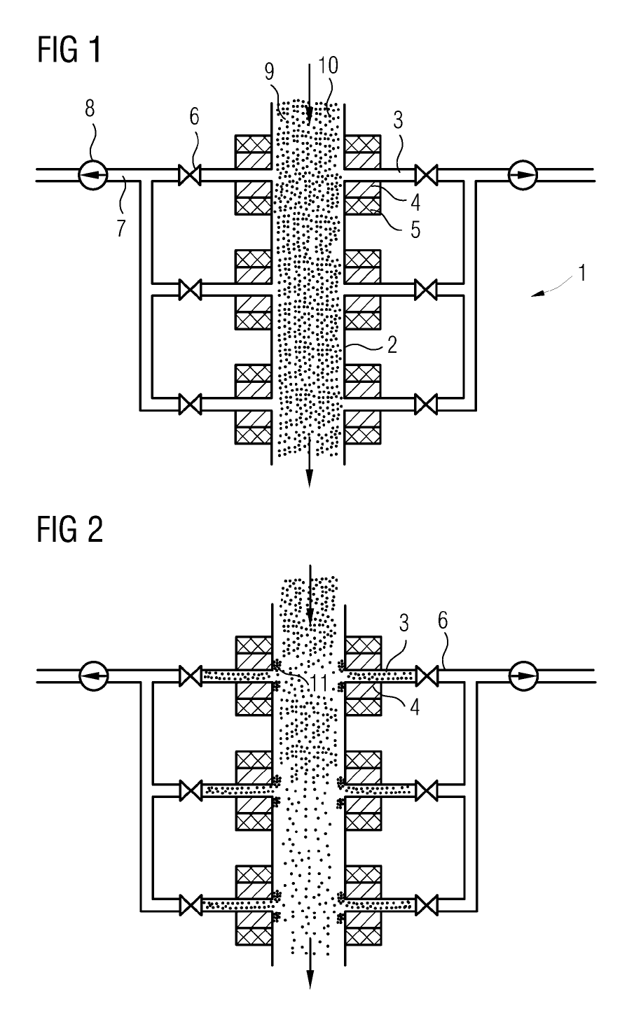

The device 1 shown in FIGS. 1 to 3 comprises a tubular reactor 2, which has a plurality of suction lines 3. The reactor 2 has a plurality of suction lines 3 arranged successively in the flow direction; two suction lines 3 lie opposite one another in each case.

Each suction line 3 is surrounded by an annularly formed permanent magnet 4. Each permanent magnet 4 is surrounded by a coil winding 5, with which the magnetic field generated by the permanent magnet 4 can be amplified or attenuated. The coil windings 5 are connected to a control device (not shown).

Each suction line 3 can be closed and opened by means of a shut-off valve 6. The various suction lines 3 open into suction lines 7, in each of which there is a pump generating a negative pressure.

The arrows in the drawings indicate the flow direction of the suspension. A suspension 10 is applied to the inlet 9 of the reactor 2. The suspension consists of water, ground ore and optionally sand. The particle size of the ground ore may vary.

Under the effect of the magnetic fields of the permanent magnets 4, ferromagnetic particles 11 accumulate on the inner side of the reactor in the region of the permanent magnets 4, as shown in FIG. 2. These accumulations are formed on all the permanent magnets 4, which are arranged successively in the flow direction in the reactor 2. Since the shut-off valves 6 are closed, the ferromagnetic particles enter the suction lines 3 only as far as the shut-off valves 6. The strength of the magnetic fields of the permanent magnets 4 can be controlled by means of the coil windings 5, that is to say the magnitude of the magnetic field can be increased or decreased.

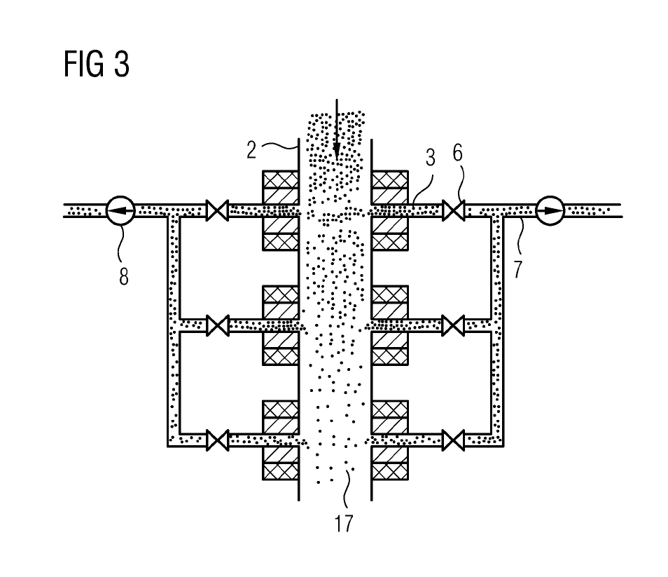

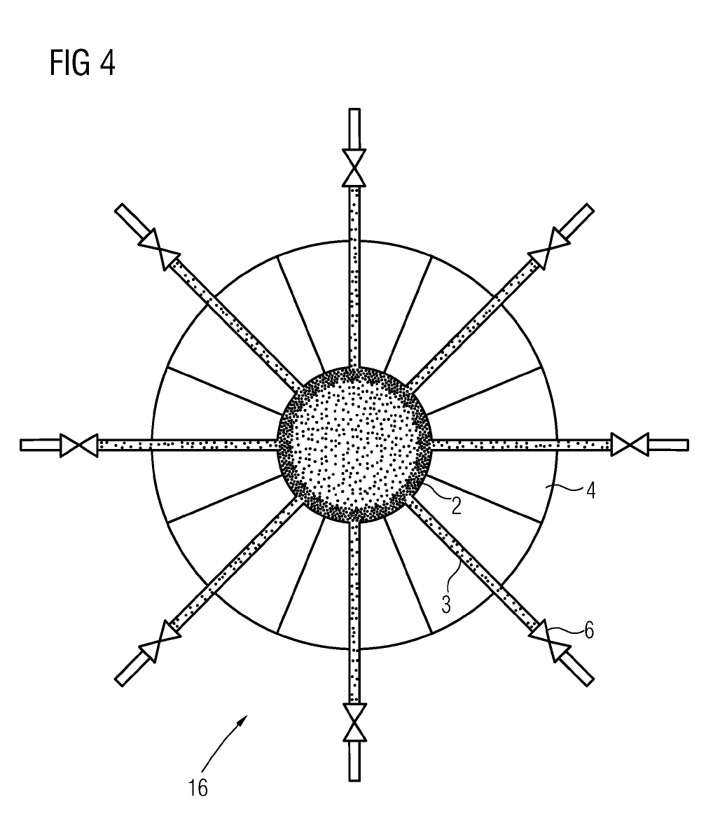

FIG. 3 shows the device 1 during suction of the ferromagnetic particles. In this state, the shut-off valves 6 have been opened by a control device. A negative pressure has been generated by a pump 8 in the suction lines 7, which are connected to the suction lines 3. Correspondingly, the ferromagnetic particles are separated from the suspension 10 via the suction lines 3 and the suction lines 7, so that they can be collected in a storage container. The suction of the ferromagnetic particles takes place with a reduced magnetic force by the coil windings 5 being controlled accordingly. The ferromagnetic particles are separated from the suspension with a high purity, and the separation process can be influenced by control of the magnetic fields using the coil winding 5. The non-ferromagnetic particles, which remain in the suspension, leave the reactor 2 via an outlet 17.

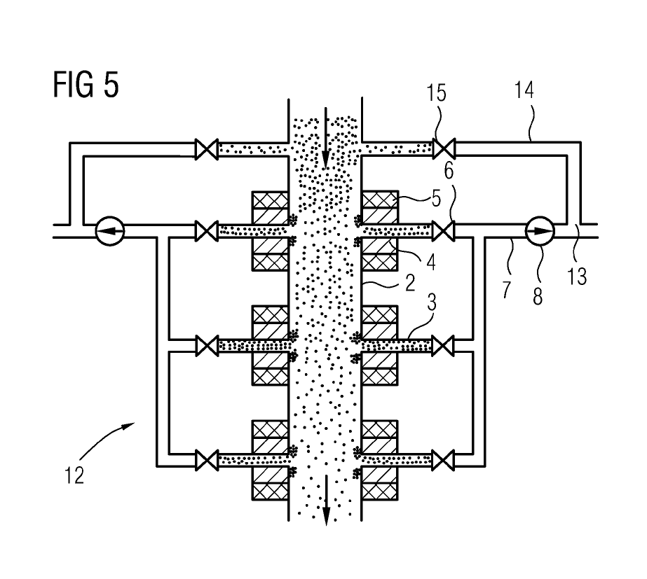

FIG. 4 shows a device 16 for separating ferromagnetic particles in a plan view. As shown in FIG. 4, a plurality of suction lines 3 distributed over the circumference open into the reactor 2. Each suction line 3 is surrounded by a permanent magnet 4, and the permanent magnets 4 are arranged segmentally around the reactor 2 and polarized in sectors. The shut-off valves 6 close the suction lines 3. Under the effect of the magnetic fields of the permanent magnets 4, ferromagnetic particles accumulate on the inside of the reactor 2 and enter the suction lines 3. Other non-ferromagnetic particles, such as sand, flow axially through the reactor 2 without being affected.

FIG. 5 shows another exemplary embodiment of a device 12 for separating ferromagnetic particles from a suspension, components which are the same being denoted by the same references.

In accordance with the exemplary embodiment shown in FIGS. 1 to 3, the device 12 comprises a reactor 2 having a plurality of suction lines 3, which open into common suction lines 7 in which a negative pressure is generated by means of a pump 8. Opening the shut-off valves 6 makes it possible to suction ferromagnetic particles which have accumulated on the inside of the reactor 2, in which case the magnetic field may simultaneously be reduced by the coil winding 5. The suction lines 7 contain a junction 13, to which a return line 14 is connected, which can be opened or closed in a controlled manner by means of a shut-off valve 15. When the shut-off valve 15 is closed, the ferromagnetic particles travel to a storage container (not shown). If the shut-off valve 15 is opened, however, a part of the separated suspension comprising the ferromagnetic particles travels back into the reactor 2 through the return line 14. By means of this return line 14, the separated part of the suspension can be fed through the reactor again, which is recommendable in particular when carrying out the first suction stage since the separated part of the suspension may then still comprise undesired contaminants.

The control of the individual shut-off valves 6, 15 and the control of the coil windings 5 are carried out by a control instrument (not shown).

What is claimed is:

1-13. (canceled)

14. A device for separating ferromagnetic particles from a suspension, comprising a tubular reactor through which the suspension can flow and which has at least one magnet, wherein the reactor has at least one suction line branching off from the reactor, to which a negative pressure can be applied and which is surrounded by a permanent magnet in the region of the branching, and wherein the device comprises a plurality of suction lines arranged successively in the flow direction, each of which is surrounded by a permanent magnet in the region of the branching.

15. The device according to claim 14, wherein the permanent magnet is surrounded by a coil winding which allows magnetic field control.

16. The device according to claim 14, wherein the device comprises a plurality of suction lines arranged distributed in the circumferential direction of the reactor, each of which is surrounded by a permanent magnet in the region of the branching, neighboring permanent magnets being polarized alternately.

17. The device according to claim 14, wherein the at least one suction line comprises a controllable shut-off valve.

18. The device according to claim 14, wherein each of the plurality of suction lines comprises a controllable shut-off valve.

19. The device according to claim 15, wherein the plurality of suction lines are connected together.

20. The device according to claim 14, wherein the at least one suction line is connected to a return line opening into the reactor.

21. The device according to claim 14, wherein the plurality of or all of the suction lines are connected to a return line opening into the reactor.

22. The device according to claim 14, wherein the permanent magnet is formed as a ring magnet.

23. A method for separating ferromagnetic particles from a suspension, with a tubular reactor through which the suspension can flow and which has at least one magnet, the method comprising:
applying a negative pressure to at least one suction line branching off from the reactor, wherein the at least one suction line is surrounded by a permanent magnet and via which the ferromagnetic particles are separated, and
feeding the suspension past at least one of: a plurality of suction lines arranged successively in the flow direction and a plurality of suction lines arranged distributed in the circumferential direction of the reactor, wherein each suction line of said plurality of suction lines being surrounded by a permanent magnet.

24. The method according to claim 23, wherein a plurality of suction line branches off from the reactor, and wherein each of the plurality of suction lines branching off from the reactor is surrounded by a permanent magnet via which the ferromagnetic particles are separated.

25. The method according to claim 23, wherein each permanent magnet is surrounded by a coil winding which is driven by means of a magnetic field control device.

26. The method according to claim 25, wherein each permanent magnet is driven individually by means of the magnetic field control device.

27. The method according to claim 23, wherein the suspension is fed back into the reactor via a return line connected to the or a suction line.

28. A device for separating ferromagnetic particles from a suspension, comprising a tubular reactor through which the suspension can flow and which has at least one magnet, wherein the reactor has at least one suction line branching off from the reactor, to which a negative pressure can be applied and which is surrounded by a permanent magnet in the region of the branching, and wherein the device comprises a plurality of suction lines arranged distributed in the circumferential direction of the reactor, each of which is surrounded by a permanent magnet in the region of the branching, neighboring permanent magnets being polarized alternately.

29. The device according to claim 28, wherein the permanent magnet is surrounded by a coil winding which allows magnetic field control.

30. The device according to claim 28, wherein the at least one suction line comprises a controllable shut-off valve.

31. The device according to claim 28, wherein each of the plurality of suction lines comprises a controllable shut-off valve.

32. The device according to claim 28, wherein the plurality of suction lines are connected together.

33. The device according to claim 28, wherein the at least one suction line is connected to a return line opening into the reactor.
